(19) United States
(12) Patent Application Publication
(10) Pub. No.: US 2014/0361979 A1
(43) Pub. Date: Dec. 11, 2014

(54) GRIP SENSOR DEVICE AND GRIP SENSING METHOD

(71) Applicant: Samsung Electronics Co., Ltd., Suwon-si (KR)

(72) Inventors: Jeong WOO, Daegu (KR); Seung-Hee RYU, Daegu (KR); Hyun-Suk CHOI, Daegu (KR)

(73) Assignee: Samsung Electronics Co., Ltd., Suwon-si (KR)

(21) Appl. No.: 14/278,501

(22) Filed: May 15, 2014

(30) Foreign Application Priority Data
Jun. 5, 2013 (KR) 10-2013-0064517

(51) Int. Cl. G01B 7/14; H04B 1/48; G06F 3/041; H01Q 1/24

(52) U.S. Cl. CPC G01B 7/14; H01Q 1/243; H04B 1/48; G06F 3/0414; H04B 2001/485
USPC 345/156; 343/702; 324/658; 455/78

(57) ABSTRACT

A grip sensor device and a grip sensing method are provided. The grip sensor device includes an antenna that is formed of metal within a mobile electronic device and communicates a signal of a first frequency and a grip sensor module that is formed within the mobile electronic device, is electrically connected to the antenna, and outputs a proximity detection signal according to proximity of an external object to the antenna.

### CROSS-REFERENCE TO RELATED APPLICATION(S)

This application claims the benefit under 35 U.S.C. §119(a) of a Korean patent application filed on Jun. 5, 2013 in the Korean Intellectual Property Office and assigned Serial number 10-2013-0064517, the entire disclosure of which is hereby incorporated by reference.

### TECHNICAL FIELD

The present disclosure relates to a mobile electronic device. More particularly, the present disclosure relates to a grip sensor device in a mobile electronic device and a grip sensing method.

### BACKGROUND

Currently, mobile electronic devices have been increasingly developed and used. For example, the mobile electronic devices including a mobile phone, a smart phone, and a tablet Personal Computer (PC) perform a mobile communication function, a camera function, a video reproduction function, a web browser function, and the like, and to this end, various components and electrical elements such as an antenna, a speaker, a chip, and the like are mounted to the mobile electronic devices.

However, the mobile electronic devices are being required to become slim and compact for user convenience in carrying them, and have a limitation in mounting the various components and electrical elements such as the antenna, the speaker, the chip, and the like therein due to the slimness and the compactness.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a grip sensor device and a grip sensing method, which can reduce a mounting space for various components and electrical elements, and material costs of a mobile electronic device, by integrating some of the various components and electrical elements within the mobile electronic device.

Another aspect of the present disclosure is to provide a grip sensor device and a grip sensing method, in which a metallic antenna within a mobile electronic device is used as a metal pad required for grip sensing so that a separate metal pad is unnecessary for the grip sensing, thereby reducing a mounting space and material costs.

At least one of the aforementioned aspects of the present disclosure can be achieved by configurations which will be described below.

In accordance with an aspect of the present disclosure, a grip sensor device is provided. The grip sensor device includes an antenna that is formed of a metal within a mobile electronic device and communicates a signal of a first frequency and a grip sensor module that is formed within the mobile electronic device, is electrically connected to the antenna, and outputs a proximity detection signal according to proximity of an external object to the antenna.

In accordance with another aspect of the present disclosure, a method of sensing a grip is provided. The method includes providing a predetermined electrical signal to an antenna in a mobile electronic device, detecting a change in the electrical signal when an external object approaches the antenna, and outputting a proximity detection signal according to the detecting of the change in the electrical signal.

In accordance with another aspect of the present disclosure, a mobile electronic device is provided. The mobile electronic device includes an antenna that is formed within the mobile electronic device and communicates a signal of a first frequency, a sensor module that is formed within the mobile electronic device, is electrically connected to the antenna, and outputs a detection signal when an external object approaches the antenna, and a controller that determines whether the mobile electronic device is gripped by a user, by using the detection signal output from the sensor module when the external object approaches the antenna, and controls a predetermined function of an application being executed within the mobile electronic device to be performed.

In accordance with another aspect of the present disclosure, a method of performing a function by using grip sensing in a mobile electronic device is provided. The method includes detecting whether the mobile electronic device is gripped by a user, by using a detection signal output from a sensor module when an external object approaches an antenna and performing a predetermined function of an application being executed in the mobile electronic device when the mobile electronic device is gripped by the user.

As described above, according to the various embodiments of the present disclosure, a user's contact with the mobile electronic device is detected through the antenna and the grip sensor so that a separate metal pad for grip sensing, for example, a separate Printed Circuit Board (PCB) needs not to be mounted to the mobile electronic device, thereby reducing a mounting space and material costs of the mobile electronic device.

Furthermore, according to the various embodiments of the present disclosure, the antenna such as a Near Field Communication (NFC) antenna is used for grip sensing so that the antenna can be utilized for both communication and grip sensing and the grip sensing can be performed by using the Low Pass Filter (LPF) without exerting any influence on the communication using the antenna.

Moreover, according to the various embodiments of the present disclosure, a photography function is performed when a user performs a grip motion of holding or grasping the mobile electronic device, for example, when the user grips the mobile electronic device, so that the user can more easily perform a self-photography operation by taking a grip motion such as contact with his/her hand holding the mobile electronic device.

In addition, according to the various embodiments of the present disclosure, when a user performs communication by using the mobile electronic device, the mobile electronic device can detect a grip motion of holding or grasping of itself and make a control such that a performance of the antenna is not degraded by the grip motion, thereby preventing degradation of the communication performance due to the user's grip motion.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram schematically illustrating a mobile electronic device according to an embodiment of the present disclosure;

FIG. 2 is a front perspective view of a mobile electronic device according to an embodiment of the present disclosure;

FIG. 3 is a rear perspective view of a mobile electronic device according to an embodiment of the present disclosure;

FIG. 4 is an exploded perspective view of a mobile electronic device according to an embodiment of the present disclosure;

FIG. 5 illustrates a principle of a grip sensor device according to an embodiment of the present disclosure;

FIG. 6 is a block diagram illustrating a configuration of a grip sensor device according to an embodiment of the present disclosure;

FIG. 7 is a specific circuit diagram of a grip sensor device according to an embodiment of the present disclosure;

FIG. 8 is a flowchart illustrating a method of performing a function using a grip sensor device in a mobile electronic device according to an embodiment of the present disclosure;

FIG. 9 is a flowchart illustrating a photography method using a grip sensor device according to a first embodiment of the present disclosure;

FIGS. 10A, 10B, and 10C illustrate an example of a screen for describing the photography method using the grip sensor device according to the first embodiment of the present disclosure;

FIG. 11 is a flowchart illustrating a photography method using a grip sensor device according to a second embodiment of the present disclosure;

FIGS. 12A, 12B, and 12C illustrate an example of a screen for describing the photography method using the grip sensor device according to the second embodiment of the present disclosure; and

FIG. 13 is a flowchart illustrating a method of controlling characteristic impedance of an antenna by using a grip sensing operation according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

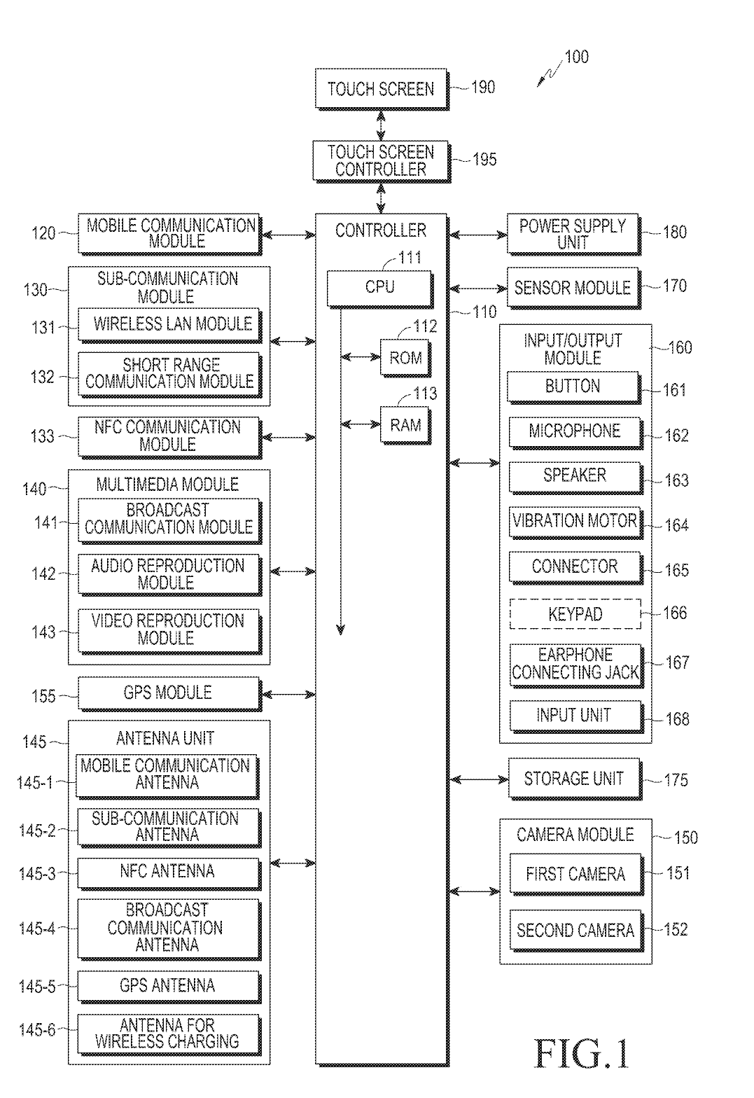

FIG. 1 is a block diagram schematically illustrating a mobile electronic device according to an embodiment of the present disclosure.

Referring to FIG. 1, a user terminal 100 (hereinafter, also referred to as a ‘device’) may be connected with an external device (not illustrated) using a mobile communication module 120, a sub-communication module 130, and a connector 165, but is not limited thereto. The external device may include a different device (not illustrated) from the user terminal 100, such as a mobile phone (not illustrated), a smart phone (not illustrated), a tablet Personal Computer (PC) (not illustrated), and a server (not illustrated).

Referring to FIG. 1, the device 100 includes a display unit including a touch screen 190 and a display controller or touch screen controller 195. Further, the device 100 includes a controller 110, the mobile communication module 120, the sub-communication module 130, a Near Field Communication (NFC) module 133, a multimedia module 140, a camera module 150, a Global Positioning System (GPS) module 155, an input/output module 160, a sensor module 170, a power supply unit 180, and a storage unit 175. The sub-communication module 130 includes at least one of a wireless LAN module 131 and a short range communication module 132, and the multimedia module 140 includes at least one of a broadcast communication module 141, an audio reproduction module 142, and a video reproduction module 143. The camera module 150 includes at least one of a first camera 151 and a second camera 152, and the input/output module 160 includes at least one of a button 161, a microphone 162, a speaker 163, a vibration motor 164, a connector 165, and a keypad 166. The input/output module may further include an earphone connecting jack 167 and an input unit 168.

The controller 110 may include a Central Processing Unit (CPU) 111, a Read Only Memory (ROM) 112 storing a control program for controlling the device 100, and a Random Access Memory (RAM) 113 which stores signals or data input from an exterior of the device 100 or is used as a storage region for operations performed by the device 100. The CPU 111 may include a single core, a dual core, a triple core, or a quad core, and the like. The CPU 111, the ROM 112 and the RAM 113 may be connected with each other through internal buses and the like.

The controller 110 may control the mobile communication module 120, the sub-communication module 130, the multimedia module 140, the camera module 150, the GPS module 155, the input/output module 160, the sensor module 170, the power supply unit 180, the storage unit 175, the touch screen 190, and the touch screen controller 195.

According to an embodiment of the present disclosure, the controller 110 may determine whether the mobile electronic device 100 is grasped by a user, by using a detection signal output from the sensor module 170 when an external object, for example, the user's finger closely approaches or contacts an antenna. When the mobile electronic device 100 has been grasped by the user, the controller 110 may make a control such that a predetermined function of an application being executed in the mobile electronic device 100 is performed. For example, when an external object contacts or closely approaches a part of the mobile electronic device 100, the controller 110 may control such that camera photography is performed. Furthermore, when an external object contacts or closely approaches the mobile electronic device 100, the controller 110 may control characteristic impedance of a main antenna to be changed, in order to prevent a wireless communication performance of the main antenna (e.g., a mobile communication antenna 145-1) from being degraded by the external object.

The mobile communication module 120 enables the device 100 to be connected with the external device through mobile communication, by using the main antenna (e.g., the mobile communication antenna 145-1) configured with one antenna or a plurality of antennas under the control of the controller 110. The mobile communication module 120 transmits/receives a wireless signal for a voice call, a video call, a Short Message Service (SMS), or a Multimedia Message Service (MMS), and image data transmission according to an embodiment of the present disclosure to/from a mobile phone (not illustrated), a smart phone (not illustrated), a tablet PC, or another device (not illustrated), which has a phone number input into the device 100.

The sub-communication module 130 may include at least one of the wireless LAN module 131 and the short range communication module 132 but is not limited thereto. For example, the sub-communication module 130 may include only the wireless LAN module 131, only the short range communication module 132, or both the wireless LAN module 131 and the short range communication module 132.

The wireless LAN module 131 may be connected to the Internet at a place where a wireless Access Point (AP) (not illustrated) is installed, by using a sub-communication antenna 145-2, for example, a wireless LAN antenna or a Wi-Fi antenna under the control of the controller 110. The wireless LAN module 131 supports a wireless LAN standard (IEEE802.11x) of the Institute of Electrical and Electronics Engineers (IEEE). The short range communication module 132 may wirelessly perform short range communication between the device 100 and an image forming device (not illustrated) by using the sub-communication antenna 145-2, for example, a Bluetooth antenna or a Zigbee antenna under the control of the controller 110. The short range communication scheme may include at least one of Bluetooth, Zigbee, and Infrared Data Association (IrDA) communication. The sub-communication antenna 145-2 may include at least one or more of a Bluetooth antenna, a Wi-Fi antenna, and a Zigbee antenna.

The NFC communication module 133 may wirelessly perform NFC communication between the device 100 and another device by using an NFC antenna 145-3 under the control of the controller 110.

The device 100 may include at least one of the mobile communication module 120, the wireless LAN module 131 and the short range communication module 132 according to a performance thereof. For example, the device 100 may include combinations of the mobile communication module 120, the wireless LAN module 131, the short-range communication module 132, and the NFC communication module 133 according to the performance thereof.

The multimedia module 140 may include the broadcast communication module 141, the audio reproduction module 142 and the video reproduction module 143, or a combination thereof. The broadcast communication module 141 may receive broadcast signals (e.g., TV broadcast signals, radio broadcast signals, and data broadcast signals) and broadcast additional information (e.g., Electronic Program Guide (EPG) and Electronic Service Guide (ESG)), which are transmitted from broadcast stations, through broadcast and communication antennas (not illustrated) under a control of the controller 110. The audio reproduction module 142 may reproduce a stored or received digital audio file (e.g., a file having a file extension of mp3, wma, ogg, way, and the like) under the control of the controller 110. The video reproduction module 143 may reproduce a stored or received digital video file (e.g., a file having a file extension of mpeg, mpg, mp4, avi, mov, mkv, and the like) under the control of the controller 110. The video reproduction module 143 may reproduce a digital audio file.

The multimedia module 140 may include the audio reproduction module 142, the video reproduction module 143, and the broadcast communication module 141 or a combination thereof. For example, the multimedia module 140 may include the audio reproduction module 142 and the video reproduction module 143 except for the broadcast communication module 141. Also, the audio reproduction module 142 or the video reproduction module 143 of the multimedia module 140 may be included in the controller 110.

The GPS module 155 may receive radio waves from a plurality of GPS satellites (not illustrated) in Earth's orbit by using a GPS antenna 145-5, and may calculate a position of the device 100 by using Time of Arrival information from the GPS satellites (not illustrated) to the device 100.

An antenna unit 145 may include a plurality of antennas 145-1 to 145-6. The plurality of antennas 145-1 to 145-6 may include at least one or more of the mobile communication antenna 145-1, the sub-communication antenna 145-2, the NFC antenna 145-3, the broadcast communication antenna 145-4, the GPS antenna 145-5, and an antenna for wireless charging 145-6.

The mobile communication antenna 145-1 may be a main antenna, and may include one or more of various communication antennas including a Long Term Evolution (LTE) communication antenna, a 3 G communication antenna, and the like. The sub-communication antenna 145-2 may include a Wi-Fi antenna for wireless LAN communication, and a Bluetooth antenna and a Zigbee antenna for short range wireless communication. The NFC antenna 145-3 may be provided together with the wireless charging antenna 145-6 (also referred to as a ‘wireless charging coil’) for wirelessly charging the battery 40 of the mobile electronic device 100. The broadcast antenna 145-4 may be a terrestrial Digital Multimedia Broadcast (DMB) antenna. The GPS antenna 145-5 may also be included in the sub-communication antenna 145-2 in some cases.

The camera module 150 may include at least one of the first camera 151 and the second camera 152, each of which photographs a still image or a moving image under the control of the controller 110. In addition, the first camera 151 or the second camera 152 may include an auxiliary light source (e.g. a flash (not illustrated)) that provides an amount of light required for photography. The first camera 151 may be disposed on a rear surface of the device 100, and the second camera 152 may be disposed on a front surface of the device 100.

The input/output module 160 may include at least one of a plurality of buttons 161, the microphone 162, the speaker 163, the vibration motor 164, the connector 165, the keypad 166, the earphone connecting jack 167, and the input unit 168. However, it is noted that the input/output module 160 may also include items other than those discussed above.

The buttons 161 may be disposed on a front surface, a side surface or a rear surface of a housing of the device 100, and may include at least one of a power/lock button (not illustrated), a volume control button (not illustrated), a menu button, a home button, a back button, and a search button.

The microphone 162 receives a voice or a sound to generate an electrical signal under the control of the controller 110.

The speaker 163 may output sounds corresponding to various signals (e.g., a wireless signal, a broadcast signal, a digital audio file, a digital video file, photography or the like) of the mobile communication module 120, the sub-communication module 130, the multimedia module 140, or the camera module 150 to the outside of the device 100 under the control of the controller 110. The speaker 163 may output sounds (e.g., a button operation tone corresponding to a voice call or call connection tone) corresponding to functions performed by the device 100. One or more speakers 163 may be arranged at a proper position or positions of the housing of the device 100.

The vibration motor 164 may convert an electronic signal to mechanical vibration under the control of the controller 110. For example, the device 100 in a vibration mode operates the vibration motor 164 when receiving a voice call from another device (not illustrated). One or more vibration motors 164 may be provided within the housing of the device 100. The vibration motor 164 may operate in response to a touch operation of a user touching the touch screen 190, and a continuous movement of a touch on the touch screen 190.

The connector 165 may be used as an interface which interconnects the mobile device 100 and an external device (not illustrated) or a power source (not illustrated). The device 100 may transmit data stored in the storage unit 175 of the device 100 to the external device (not illustrated) or may receive data from an external device (not illustrated) through a wired cable connected to the connector 165 under the control of the controller 110. The device 100 may receive power from a power source (not illustrated) through the wired cable connected to the connector 165 or charge a battery (not illustrated).

The keypad 166 may receive a key input from a user for control of the device 100. The keypad 166 may include a physical keypad (not illustrated) formed in the device 100 or a virtual keypad (not illustrated) displayed on the touch screen 190 but is not limited thereto. The physical keypad (not illustrated) arranged on the device 100 may be excluded according to the performance or structure of the device 100.

An earphone (not illustrated) is inserted into the earphone connecting jack 167 to be connected with the device 100.

The input unit 168 may be inserted into the device 100 to be stored in the device 100, and may be withdrawn and detached from the device 100 when being used. An attachment/detachment recognition switch (not illustrated) operating in correspondence to attachment or detachment of the input unit 168 is provided at one area within the device 100 where the input unit 168 is inserted, and thus may provide signals corresponding to the attachment and the detachment of the input unit 168 to the controller 110.

The attachment/detachment switch is provided at the area where the input unit 168 is inserted, and directly/indirectly contacts the input unit 168 when the input unit 168 is mounted on the area. Accordingly, the attachment/detachment recognition switch generates a signal corresponding to the attachment or the detachment of the input unit 168 based on the direct or indirect contact with the input unit 168, and then provides the generated signal to the controller 110.

The sensor module 170 includes at least one sensor for detecting a status of the portable device 100. For example, the sensor module 170 may include a proximity sensor 174 for detecting a user's access to the device 100 or an approach of an external object such as a finger or a pen 200 to the screen, an illumination sensor 172 for detecting an amount of light around the device 100, or an acceleration sensor 172 for detecting a motion of the device 100 (e.g., rotation of the device 100, or acceleration or vibration applied to the device 100). Furthermore, the sensor module 170 may further include a grip sensor 510, 610 for detecting contact on the device 100 generated by a grip motion (also referred to as ‘grasp’) in which a user holds or grasps the device 100. The grip sensor 510, 610 may be connected with any one of the plurality of antennas 145-1 to 145-5, and may detect the contact on the device 100 generated according to a change in permittivity of any one of the plurality of antennas due to a user's grasp on the device 100.

At least one sensor may detect a status of the device 100 including an orientation and an inclination of the device 100, and may generate a signal corresponding to the detection to transmit the signal to the controller 110. The sensors of the sensor module 170 may be added or omitted according to the performance of the device 100.

The power supply unit 180 may supply power to one battery pack 41 or a plurality of battery packs (not illustrated) disposed in the housing of the device 100 under the control of the controller 110. The one battery pack or the plurality of battery packs supply power to the device 100. Further, the power supply unit 180 may supply the device 100 with power input from an external power source (not illustrated) through a wired cable connected to the connector 165.

The storage unit 175 may store signals or data input/output to correspond to an operation of the mobile communication module 120, the sub-communication module 130, the multimedia module 140, the camera module 150, the GPS module 155, the input/output module 160, the sensor module 170, and the touch screen 190 under the control of the controller 110. The storage unit 175 may store control programs for controlling the device 100 or the controller 110, and applications.

The term “storage unit” may be used as a term that refers to the storage unit 175, the ROM 112 and the RAM 113 in the controller 110, or a memory card (not illustrated) (e.g., a Secure Digital (SD) card or a memory stick) mounted in the device 100. Further, the storage unit may include a nonvolatile memory, a volatile memory, a Hard Disk Drive (HDD), or a Solid State Drive (SSD).

The touch screen 190 may provide a user with a User Interface (UI) corresponding to various services (e.g., a call, data transmission, broadcast, and photography). The touch screen 190 may transmit an analog signal corresponding to at least one touch input to the user interface to the touch screen controller 195. The touch screen 190 may receive at least one touch caused by various objects, for example, a user's body (e.g., fingers including a thumb) or a touchable input device, for example, the input unit 168 such as an electronic pen (a stylus pen). Also, the touch screen 190 may receive a continuous movement of one touch among at least one touch. The touch screen 190 may transmit, to the touch screen controller 195, an analog signal corresponding to the continuous movement of the touch input thereto.

In the present disclosure, the touch is not limited to a contact between the touch screen 190 and the user's body or a touchable input device, and may include a non-contact. A distance of the non-contact detected by the touch screen 190 may be changed according to the performance or the structure of the portable device 100. The touch screen 190 may be implemented in various types, for example, a resistive type, a capacitive type, an infrared type, an Electro Magnetic Resonance (EMR) type, or an acoustic wave type, and may also be implemented in combination of the one or more types or other types.

In addition, the controller 110 may detect various user inputs received through the camera module 150, the input/output module 160, and the sensor module 170, in addition to the input unit 190. The user input may include various types of information input to the device 100 such as a gesture, a voice, a pupil action, and a bio signal of the user as well as the touch. The controller 110 may control a predetermined operation or function corresponding to the detected user's input to be performed within the device 100.

Hereinafter, an external structure of the above-described mobile electronic device 100 will be described.

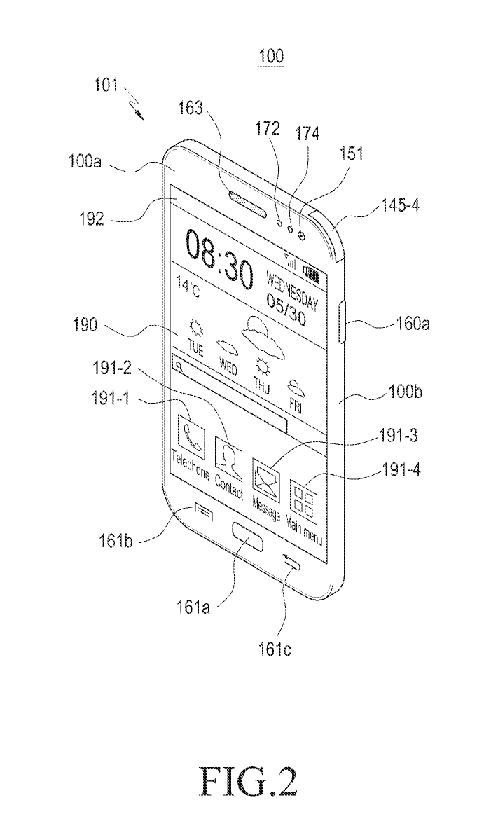

FIG. 2 is a front perspective view of a mobile electronic device according to an embodiment of the present disclosure.

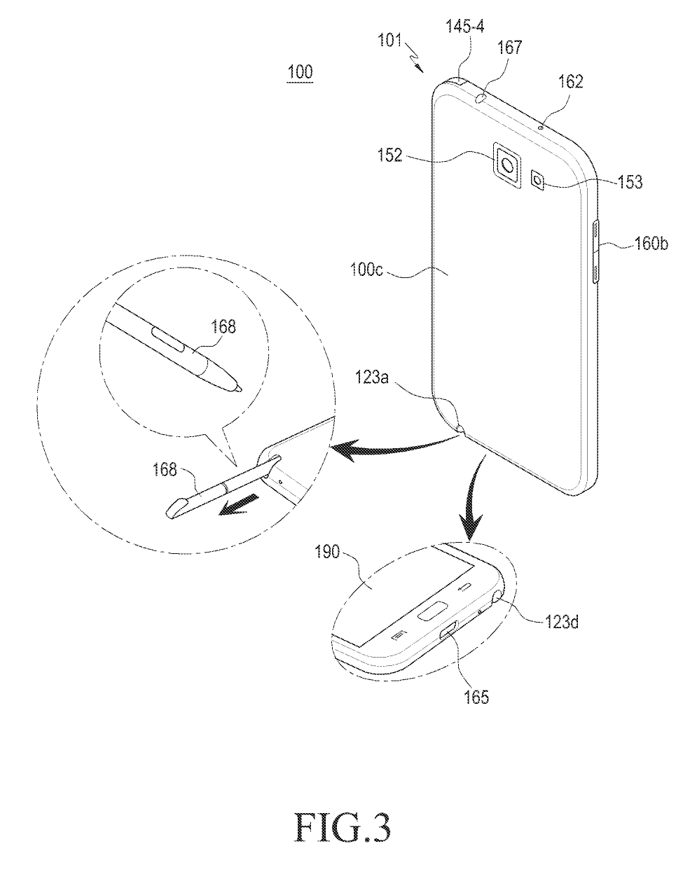

FIG. 3 is a rear perspective view of a mobile electronic device according to an embodiment of the present disclosure.

Referring to FIGS. 2 and 3, the mobile electronic device 100 may have a size by which a user may use the mobile electronic device while holding in his/her hand, and may be a bar type terminal formed of a housing 101. A touch screen 190 may be disposed in the center of a front surface 100a of the housing 101. The touch screen 190 may be formed to occupy almost all the front surface 100a of the device 100. FIG. 2 illustrates an example in which a main home screen is displayed on the touch screen 190. The main home screen is the first screen displayed on the touch screen 190 when the mobile device 100 is turned ON. Further, when the electronic device 100 has different home screens of several pages, the main home screen may be the first home screen of the home screens of several pages. Short-cut icons 191-1, 191-2, and 191-3 for executing frequently used applications, a main menu switching key 191-4, time, weather and the like may be displayed on the home screen. The main menu switching key 191-4 displays a menu screen on the screen 190. On an upper end of the touch screen 190, a status bar 192 may be formed that indicates a status of the device 100 such as a battery charging status, intensity of a received signal and current time.

A home button 161a, a menu button 161b, and a back button 161c may be formed on a lower end of the touch screen 190. The home button 161a displays the main home screen on the touch screen 190. For example, when the home button 161a is pressed in a state where a home screen different from the main home screen or the menu screen is displayed on the screen 190, the main home screen may be displayed on the screen 190. Further, when the home button 161a is selected while applications are being executed on the touch screen 190, the main home screen may be displayed on the touch screen 190. In addition, the home button 161a may be used to display recently used applications or a task manager on the touch screen 190. The menu button 161b provides a connection menu which may be used on the touch screen 190. The connection menu includes a widget addition menu, a background changing menu, a search menu, an editing menu, an environment setup menu and the like. The back button 161c may cause the screen executed just before the currently executed screen to be displayed or the most recently used application to be terminated. A first camera 151, an illumination sensor 172, and a proximity sensor 174 may be disposed at an edge of the front surface 100a of the mobile electronic device 100.

For example, a power/reset button 160a, a volume button 161b, a broadcast communication antenna 145-4 for receiving broadcast (e.g., a terrestrial DMB antenna or a satellite DMB antenna), and one or a plurality of microphones 162 may be disposed on a side surface 100b of the mobile electronic device 100. The broadcast communication antenna 145-4 be secured to the device 100 or may be formed detachably from the device 100.

Referring to FIG. 3, a second camera 152 and a flash 153 may be disposed at an upper portion of a rear surface 100c of the mobile electronic device 100.

A connector 165 is formed on a lower side surface of the mobile electronic device 100. A plurality of electrodes are formed in the connector 165, and the connector 165 may be connected to an external device by a wired cable. An earphone connecting jack 167 may be formed on an upper side surface of the mobile electronic device 100. An earphone may be inserted into the earphone connecting jack 167.

Furthermore, an inserting hole 123a into which an input unit 168 configured separately from the mobile electronic device 100, for example, a pen may be inserted may be formed on the lower side surface of the mobile electronic device 100, and the input unit 168 may be inserted into the pen inserting hole 123a.

According to an embodiment of the present disclosure, when a user closely approaches or touches the touch screen 190 of the mobile electronic device 100 by using an object such as the input unit 168 or a finger, the above-configured mobile electronic device 100 may distinguish the close approach from the touch to display the object corresponding to detection of the close approach or the object corresponding to detection of the touch on the touch screen 190, or may perform a function corresponding to the detection of the close approach or a function corresponding to the detection of the touch.

The touch screen 190 and the touch screen controller 195 for detecting the close approach and the touch according to the embodiment of the present disclosure may be implemented in various types including but not limited to a resistive type, a capacitive type, an infrared type, an EMR type, or an acoustic wave type, and may also be implemented in combination of the one or more types.

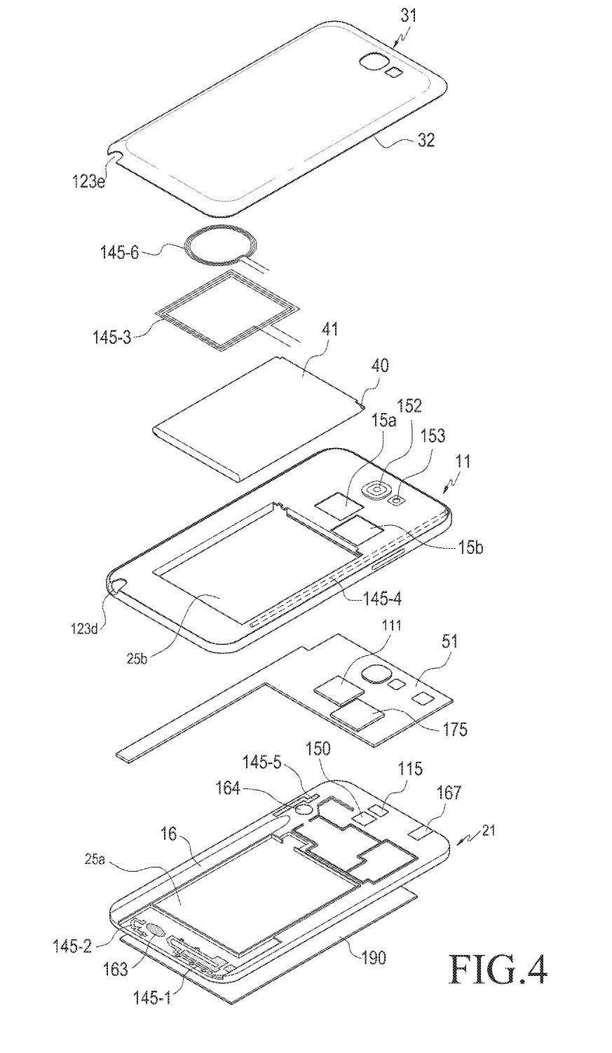

FIG. 4 is an exploded perspective view of a mobile electronic device according to an embodiment of the present disclosure.

Referring to FIG. 4, a housing 101 of the mobile electronic device 100 may be configured through a combination of a case 11 and a bracket 21. A rear cover 31 may be detachably provided on a rear surface of the case 11.

A touch screen 190 may be disposed on a front surface of the bracket 21, a rear surface of the bracket 21 may be covered with the case 11, and a circuit board 51 may be disposed between the bracket 21 and the case 11. A battery mounting surface 25a may be provided on a rear surface of the bracket 21, and an opening 25b corresponding to the battery mounting surface 25a may be formed in the case 11. The opening 25b may be provided with side walls located at a periphery of the battery mounting surface 25a. When the bracket 21 and the case 11 are coupled to each other, a battery mounting recess (not illustrated) may be formed through combination of the battery mounting surface 25a and the opening 25b, and a battery 40 may be mounted to the battery mounting recess.

The rear cover 31 is coupled to the rear surface of the case 11 to conceal and protect the battery mounting recess and the battery 40 mounted to the battery mounting recess. An NFC antenna 145-3 may be disposed between the rear cover 31 and the battery 40. The NFC antenna 145-3 may also be disposed on a front surface or a rear surface 33 of the rear cover 31. Furthermore, the NFC antenna 145-3 may also be attached to a rear surface 41 of the battery 40, or disposed separately. At this time, a wireless charging antenna 145-6 for wireless charging may also be disposed between the rear cover 31 and the battery 40 together with the NFC antenna 145-3.

The housing 101 of the mobile electronic device 100 may be substantially formed of a rectangular parallelepiped, and as a whole, may have a rectangular parallelepiped shape even though some surfaces thereof are curved. The NFC antenna 145-3 may be disposed below the rear cover 31 of the mobile electronic device 100 which is coupled to the housing 101. The lower portion of the rear cover 31 may be a portion of the rear cover 31 at the side in which a notch 123e is located, with reference to the center of the rear surface of the rear cover 31.

The case 11 may be manufactured from a metal material or an injection-molded material of synthetic resin. Although the case 11 is generally manufactured from synthetic resin, the case 11 may be manufactured from metal in some products. The case 11 may be formed with openings 15a, 15b, and 25b through which connectors and various modules mounted on the circuit board 51 or the bracket 21 may be exposed. For example, circuit devices, such as a CPU 111 or a memory (a storage unit) 175, for controlling overall functions of the mobile electronic device 100 or various modules may be equipped to the circuit board 51, and some conductive components may also be directly mounted on the circuit board 51. The CPU 111 or the memory (storage unit) 175 may be exposed through some openings 15a and 15b of the case 11. In addition, the case 11 may be provided with a space 16, where a broadcast communication antenna 145-4 can be received, on a side of the opening 25b corresponding to the battery mounting surface 25a, and may receive the broadcast communication antenna 145-4 therein. The broadcast antenna 145-4 may be a terrestrial DMB antenna or a satellite DMB antenna.

A guide hole 123a and a securing hole for receiving an input unit 168, for example, a stylus pen may be formed in the housing 101 configured through the combination of the case 11 and the bracket 21. The guide hole 123a is located on a side of the battery mounting recess 25a and is opened to one side edge of the housing 101. An opening 123d may be formed in the case 11 and a notch 123e may be formed in the rear cover 31, for opening of the guide hole 123a at the one side edge of the housing 101. The opening 123d and the notch 123e may also be formed at a different position according to a shape of the case 11 and the bracket 21.

Furthermore, the bracket 21 provides the battery mounting surface 25a, and an earphone connecting jack 167, a camera module 150, a speaker 163, a vibration motor 164, a receiver module 115, and a display module 190 may be mounted on a periphery or a side of the battery mounting surface 25a.

A plurality of antennas may be disposed on a side or an opposite side of the bracket 21. For example, a mobile communication antenna 145-1 and a sub-communication antenna 145-2 may be disposed on the side of the bracket 21, and a GPS antenna 145-5 may be disposed on the opposite side of the bracket 21. Meanwhile, at least one or more of the mobile communication antenna 145-1, the sub-communication antenna 145-2, and the GPS antenna 145-5 may be formed in an integrated form to be disposed on a side of the bracket 21.

According to various embodiments of the present disclosure, at least one of the plurality of antennas 145-1 to 145-6 of the mobile electronic device 100 may be used as a grip sensor device 200 for detecting a grip motion by which a user holds or grasps the device 100.

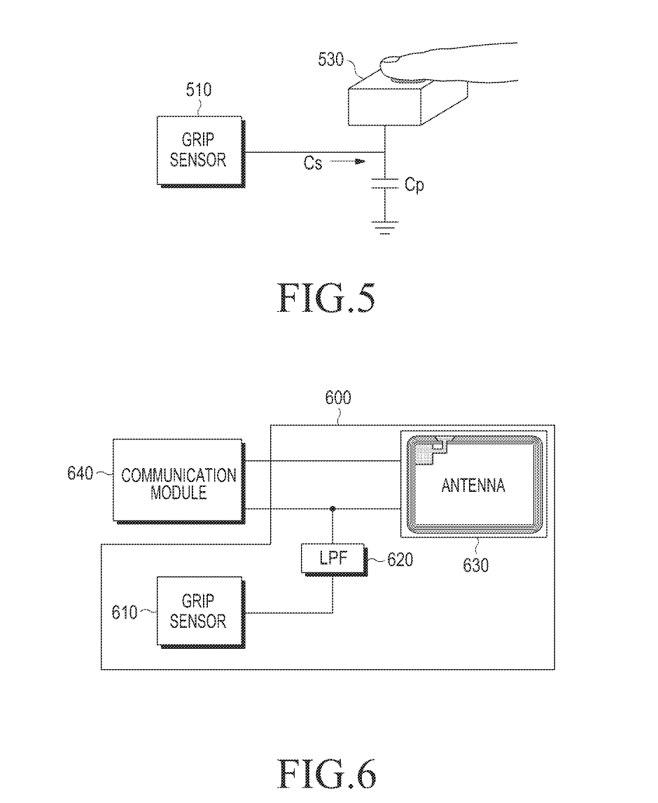

FIG. 5 illustrates a principle of a grip sensor device according to an embodiment of the present disclosure.

Referring to FIG. 5, the grip sensor device may include a grip sensor 510 and a metal pad 530. The metal pad 530 may be electrically connected with the grip sensor 510, and may be connected with a ground GND of a Printed Circuit Board (PCB). When a user contacts the metal pad 530, there may be a change between a capacitance component Cs before the contact and a capacitance component Cs' after the contact.

For example, the capacitance component Cs before the contact corresponds to a capacitance component Cp between the grip sensor 510 and the PCB ground, whereas the capacitance component Cs' after the contact corresponds to a capacitance component obtained by adding a capacitance component Cf between the contact position and the metal pad 530 to the capacitance component Cp between the grip sensor 510 and the PCB ground. The grip sensor 510 detects the contact and performs a grip sensing operation, by detecting an amount of the change between the capacitance component Cs before the contact and the capacitance component Cs' after the contact on the metal pad 530.

Such a separate metal pad 530 for the grip sensing operation in the grip sensor device may be deposited on a mechanical component of the mobile electronic device 100, or may be mounted in the form of a Flexible Printed Circuit Board (FPCB) to the mobile electronic device 100.

However, in the case in which the metal pad 530 for the grip sensing operation is deposited on the mechanical component of the device 100 or is mounted in the FPCB form to the mobile electronic device 100, the separate metal pad 530 is additionally mounted to the mobile electronic device 100 and therefore, it is troublesome to provide a space for the metal pad 530 to the mobile electronic device 100 and material costs of the mobile electronic device 100 may be increased due to the metal pad 530. Furthermore, since the metal pad 530 has conductivity, the metal pad 530 should be separated from other components, including an antenna, influenced by the conductivity so that it may be difficult to mount the metal pad 530.

Accordingly, in various embodiments of the present disclosure, metallic modules or components of the mobile electronic device 100 may be utilized as an element of the grip sensor device.

For example, in the various embodiments of the present disclosure, any one of the plurality of antennas of the mobile electronic device 100 may be utilized as the element of the grip sensor device.

FIG. 6 is a block diagram illustrating a configuration of a grip sensor device according to an embodiment of the present disclosure.

Referring to FIG. 6, the grip sensor device 600 according to the embodiment of the present disclosure may include a grip sensor 610 and an antenna 630, and may further include a Low Pass Filter (LPF) 620.

The antenna 630 may be a metallic conductive antenna. The antenna 630 may resonate in a first frequency band determined in advance, and may be a radiator having a power supply unit (not illustrated) and a ground unit (not illustrated). The antenna 630 may be connected at opposite ends thereof with a communication module 640, and the one end of the antenna 630 may be connected with the grip sensor 610 through the LPF 620. For example, the antenna 630 may be any one of a mobile communication antenna 145-1, a sub-communication antenna 145-2, an NFC antenna 145-3, a broadcast communication antenna 145-4, a GPS antenna 145-5, and a wireless charging antenna 145-6.

The communication module 640 may be any one of a mobile communication module 120, a sub-communication module 130, an NFC communication module 133, a broadcast communication module 141, and a GPS module 155, and may perform communication in the first frequency band by using the antenna 630.

In a case in which the antenna 630 corresponds to the mobile communication antenna 145-1 (or a main antenna), the antenna 630 may be any one of various mobile communication antennas including a cellular communication antenna, a Long Term Evolution (LTE) antenna, a 3 G communication antenna, a Wireless Broadband (WIBRO) antenna, and World Interoperability for Microwave Access (WIMAX), and may resonate in a mobile communication frequency band. The mobile communication frequency band may be any one of a 3 G communication frequency band, an LTE frequency band, a WIBRO frequency band, and a WIMAX frequency band, and may be any one of a 800 MHz band, a 900 MHz band, a 1.8 GHz band, a 2.1 GHz band, a 2.3 GHz band, and a band from 2 GHz to 11 GHz.

In a case in which the antenna 630 corresponds to the sub-communication antenna 145-2, the antenna 630 may be a Wi-Fi antenna for wireless LAN communication or a Bluetooth antenna for short range wireless communication, and may resonate in a sub-communication frequency band. The sub-communication frequency band may be a 2.4 GHz band in the case of the Wi-Fi antenna and a 2.45 GHz band in the case of the Bluetooth antenna. The Wi-Fi antenna and the Bluetooth antenna may be commonly used.

The antenna 630 may correspond to the NFC antenna 145-3, and may resonate in an NFC frequency band. The NFC frequency band may be a 56 MHz band.

In a case in which the antenna 630 corresponds to the broadcast communication antenna 145-4, the antenna 630 may be a satellite DMB antenna or a terrestrial DMB antenna, and may resonate in a satellite DMB band or a terrestrial DMB band. The satellite DMB band may be a 2.5 GHz band, and the terrestrial DMB band may be a band from 180 MHz to 210 MHz.

Meanwhile, although the antenna 630 corresponds to any one of the mobile communication antenna 145-1, the sub-communication antenna 145-2, the NFC antenna 145-3, the broadcast communication antenna 145-4, the GPS antenna 145-5, and the wireless charging antenna 145-6 in the above-described various embodiments of the present disclosure, any antenna corresponding to a metallic conductive antenna and using the first frequency (e.g., hundreds of MHz or several GHz) band may be used as the antenna 630 without any specific limitations.

The antenna 630 and the communication module 640 are electrically connected with each other, and an alternating current of hundreds of mA or several A may flow between the antenna 630 and the communication module 640 when the antenna 630 resonates (performs communication) in the first frequency (e.g., hundreds of MHz or several GHz) band or is in a standby mode (does not perform communication).

If contact is generated by a user when the antenna 630 resonates in the first frequency (e.g., hundreds of MHz or several GHz) band or is in the standby mode, a current of several mA, corresponding to a second predetermined frequency (e.g., hundreds of KHz) band lower than the first frequency band, may be generated by the contact.

The grip sensor 610 may be a grip sensor module. The grip sensor 610 may provide signals of the second frequency (hundreds of KHz) lower than the first frequency to the antenna 630, perform a grip sensing operation by detecting the user's contact with the antenna 630 through detection of a change in the current of several mA generated from the antenna 630, for example, a change in permittivity, and output a detection signal as a result of the grip sensing operation.

At this time, the LPF 620 allowing a low frequency band to pass may be further included between the antenna 630 and the grip sensor 610. Between the antenna 630 and the grip sensor 610, the LPF 620 allows only the current of several mA by the second frequency (e.g., hundreds of KHz) lower than the first frequency in the whole frequency band to be transferred to the grip sensor 610. Since the current by the second frequency (e.g., hundreds of KHz) is a current similar to a direct current and does not exert an influence on the communication, the antenna 630 may serve as both a radiator for the communication and a metal pad for the grip sensing operation.

Hereinafter, a specific circuit of the above-described grip sensor device according to the embodiment of the present disclosure will be described.

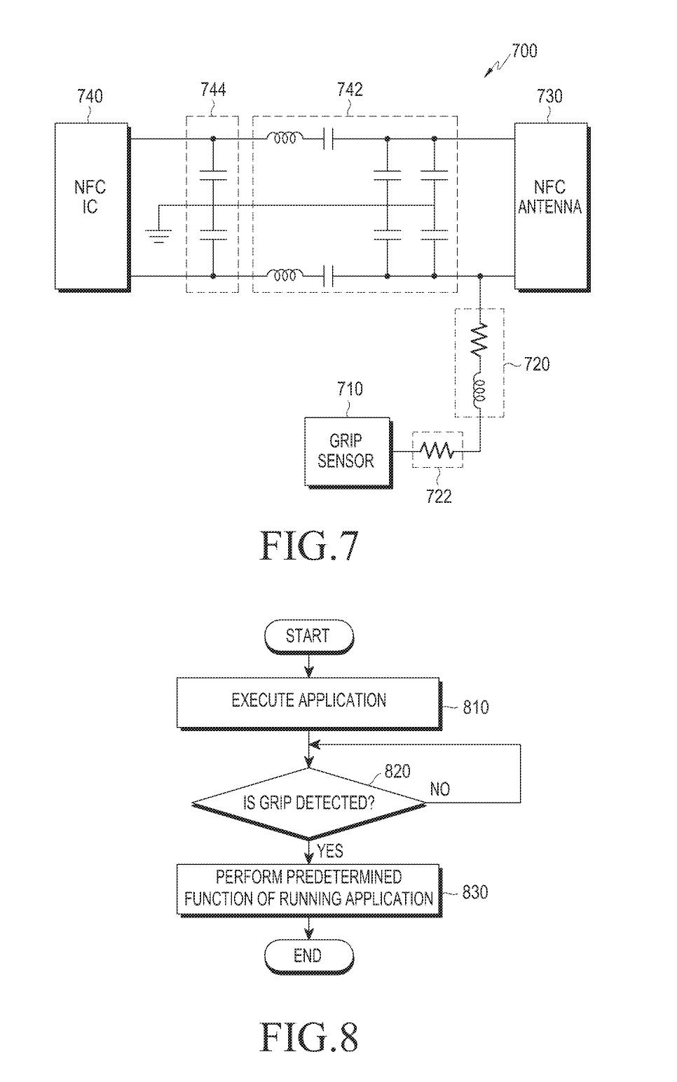

FIG. 7 is a specific circuit diagram of a grip sensor device according to an embodiment of the present disclosure. It will be exemplified in FIG. 7 that the antenna 630 and the communication module 640 are implemented as an NFC antenna 730 and an NFC Integrated Circuit (IC) 740, respectively.

Referring to FIG. 7, the grip sensor device 700 may include a grip sensor 710, an LPF 720, a first noise attenuating circuit 722, the NFC antenna 730, the NFC IC 740, an impedance matching circuit 742, and a second noise attenuating circuit 744.

The NFC antenna 730 may resonate in a first frequency band, for example, a 56 MHz frequency band. The NFC antenna 730 and the NFC IC 740 may be electrically connected with each other, and the impedance matching circuit 742 and the second noise attenuating circuit 744 may be provided between the NFC antenna 730 and the NFC IC 740.

The impedance matching circuit 742 decreases loss of signals and improves NFC signal transfer characteristics, by matching impedance of the NFC antenna 730 and impedance of the NFC IC 740. A communication quality may be improved through the improvement of the signal transfer characteristics. In other words, the impedance matching circuit 742 may allow radio frequency signals of the NFC frequency band to be received to the maximum, by matching the impedance of the NFC antenna 730 with the impedance of the NFC IC 740.

The second noise attenuating circuit 744 prevents noise from being introduced into the NFC IC 740 by reducing noise temporarily generated in the NFC antenna 730 by various reasons. At this time, the noise may be a signal corresponding to a current value larger than a predetermined current value that may flow between the NFC antenna 730 and the NFC IC 740. The NFC IC 740 performs NFC communication using a frequency band of 56 MHz through the NFC antenna 730.

When the NFC antenna 730 resonates (performs communication) at a first frequency (e.g., a frequency of 56 MHz) or is in a standby mode (does not perform communication), an alternating current of hundreds of mA or several A may flow between the NFC antenna 730 and the NFC IC 740.

If contact is generated by a user when the NFC antenna 730 resonates at the first frequency (e.g., the frequency of 56 MHz) or is in the standby mode, a current of several mA, corresponding to a second frequency (e.g., hundreds of KHz) in a predetermined band lower than the first frequency, may be generated by the contact.

The grip sensor 710 may perform a grip sensing operation by detecting the user's contact with the NFC antenna 730 through detection of a change in the current of several mA generated from the NFC antenna 730, for example, a change in permittivity, and may output a detection signal as a result of the grip sensing operation.

At this time, the LPF 720 and the second noise attenuating circuit 722 may be provided between the grip sensor 710 and the NFC antenna 730.

Between the NFC antenna 730 and the grip sensor 710, the LPF 720 allows the signal of the first frequency (e.g., 56 MHz) band among the whole frequency band of the NFC antenna 730 to be interrupted, and only the current of several mA by the second frequency (e.g., hundreds of KHz) lower than the first frequency (e.g., 56 MHz) to be transferred to the grip sensor 710. The LPF 720 may include a coil that is connected at one end thereof to the NFC antenna 730 and at an opposite end thereof to the grip sensor 710, and the coil may prevent the signal of the first frequency from being provided to the sensor module. Furthermore, the LPF 720 may further include a resistor together with the coil.

According to an embodiment of the present disclosure, since the current by the second frequency (e.g., hundreds of KHz) is a current similar to a direct current and does not exert an influence on the communication, the NFC antenna 730 may serve as both a radiator for the communication and a metal pad for the grip sensing operation.

The second noise attenuating circuit 722 prevents noise from being introduced into the grip sensor 710 by reducing noise temporarily generated in the NFC antenna 730 by various reasons. The second noise attenuating circuit 722 may include a resistor that is connected at one end thereof with the LPF 720 and at an opposite end thereof with the grip sensor 710. At this time, the noise may be a signal corresponding to a current value larger than a predetermined current value that may flow between the NFC antenna 730 and the grip sensor 710.

The grip sensor device 700 according to the various embodiments of the present disclosure detects the user's contact with the mobile electronic device 100 by using the NFC antenna 730 and the grip sensor 710 so that a separate metal pad for the grip sensing, for example, a separate PCB does not have to be additionally mounted to the mobile electronic device 100, thereby reducing a mounting space and material costs of the mobile electronic device 100. Furthermore, since the grip sensor device 700 according to the various embodiments of the present disclosure uses the NFC antenna 730, the grip sensor device 700 may use the NFC antenna 730 for both the communication and the grip sensing, and may perform the grip sensing operation by using the LPF 720, without exerting any influence on the communication using the NFC antenna 730.

Meanwhile, according to another embodiment of the present disclosure, the mobile electronic device 100 may perform various functions by using the grip sensor device 700 according to the embodiment of the present disclosure.

FIG. 8 is a flowchart illustrating a method of performing a function using a grip sensor device in a mobile electronic device according to the embodiment of the present disclosure.

Referring to FIG. 8, the mobile electronic device 100 may execute an application, in operation 810. The application refers to an application program or application software that may be executed by the controller 110 including the CPU 111 in the mobile electronic device 100. The mobile electronic device 100 may execute a pre-stored application though an interface with a user or may execute an application that is downloaded from an external device (not illustrated) and installed. The application may be one of various applications including a game application, a photography application, a video application, a web browsing application, a messaging application, a mail application, a map application, and the like. In the embodiment of the present disclosure, a type of application is not limited.

The mobile electronic device 100 determines whether a grip is detected, in operation 820. For example, the mobile electronic device 100 may determine whether the grip is detected, according to a contact or proximity detection signal from the grip sensor device 700.

When a user contacts or closely approaches the location where the NFC antenna 730 of the grip sensor device 700 is mounted, a current of several mA corresponding to a second frequency (e.g., hundreds of KHz) of a predetermined band lower than a first frequency may be generated in the NFC antenna 730 by the contact or the close approach. The grip sensor 710 of the grip sensor device 700 may perform a grip sensing operation by detecting the user's contact with the NFC antenna 730 through detection of a change in the current of several mA generated from the NFC antenna 730, for example, a change in permittivity, and may output a detection signal as a result of the grip sensing operation. At this time, only the current of several mA by the second frequency (e.g., hundreds of KHz) lower than the first frequency in the whole frequency band of the NFC antenna 730 may be transferred to the grip sensor 710 by the LPF 720, allowing a low frequency band to pass, between the NFC antenna 730 and the grip sensor 710.

When the grip is detected, the mobile electronic device 100 performs a predetermined function of the running application, in operation 830. For example, in a case in which the application is a camera application, the mobile electronic device 100 may perform a photography function. Furthermore, in a case in which the application is a telephone application, the mobile electronic device 100 may perform an antenna performance control function. At this time, the application may be one of various applications including a video application, a web browsing application, a messaging application, a mail application, a map application, and the like as well as the camera application and the telephone application, and the predetermined function may be a predetermined function among functions of the various applications.

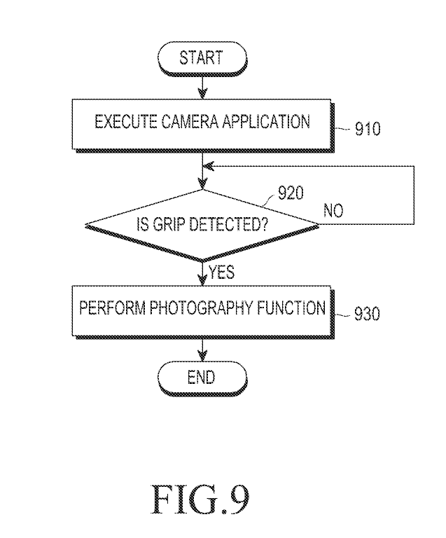

FIG. 9 is a flowchart illustrating a photography method using a grip sensor device according to a first embodiment of the present disclosure.

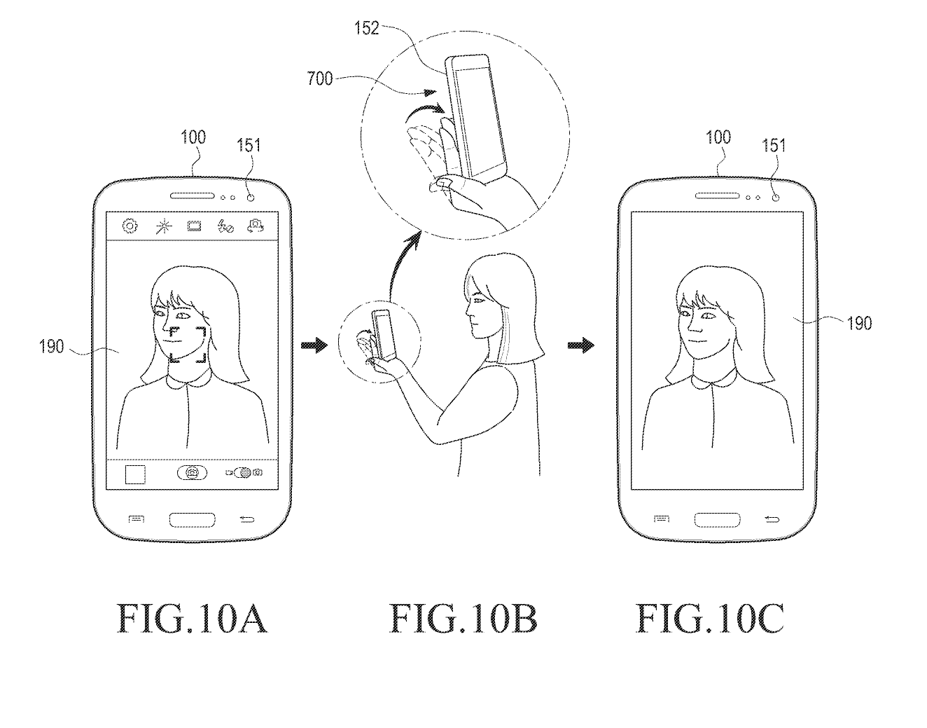

FIGS. 10A, 10B, and 10C illustrate a screen for describing the photography method using the grip sensor device according to the first embodiment of the present disclosure.

Referring to FIGS. 9, 10A, 10B, and 10C, a mobile electronic device 100 may execute a camera application, in operation 910. The mobile electronic device 100 may execute the camera application though an interface with a user or may execute a camera application that is downloaded from an external device (not illustrated) and installed. The camera application may also correspond to a camera function defined in advance in the mobile electronic device 100. When the camera application is executed, a first camera 151 or a second camera 152 may be turned on, and a preview screen may be displayed, as illustrated in FIG. 10A.

The mobile electronic device 100 determines whether a grip is detected, in operation 920. For example, while the preview screen is displayed as illustrated in FIG. 10A, the mobile electronic device 100 may determine whether the grip is detected, according to a contact or proximity detection signal from the grip sensor device 700. For example, as illustrated in FIG. 10B, a user may perform a grip motion on a mounting location of an NFC antenna 730 disposed at a rear cover 31 side of the mobile electronic device 100, and a contact or proximity detection signal may be generated by the grip motion. When the contact or proximity is made by the user, a grip sensor 710 may perform a grip sensing operation by detecting a change in a current of several mA generated from the NFC antenna 730 by the contact or proximity, for example, a change in permittivity, and may output a detection signal as a result of the grip sensing operation

When the grip is detected, the mobile electronic device 100 may perform a photography function of the camera application, in operation 930. For example, as illustrated in FIG. 10C, the mobile electronic device 100 may perform the photography function, and may display a photo taken.

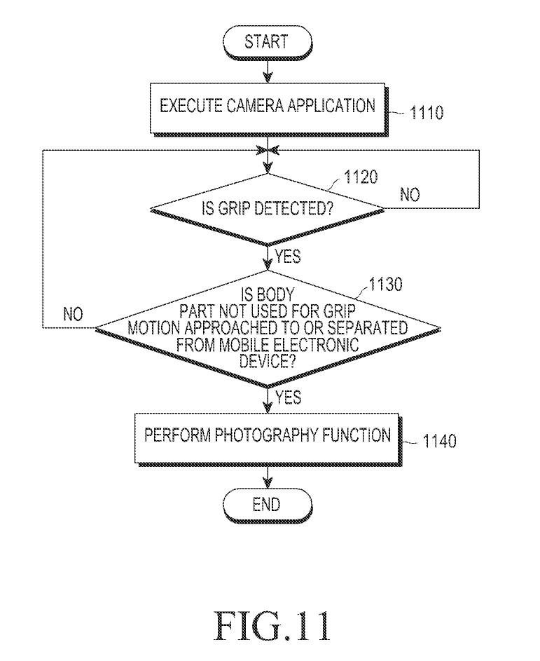

FIG. 11 is a flowchart illustrating a photography method using a grip sensor device according to a second embodiment of the present disclosure.

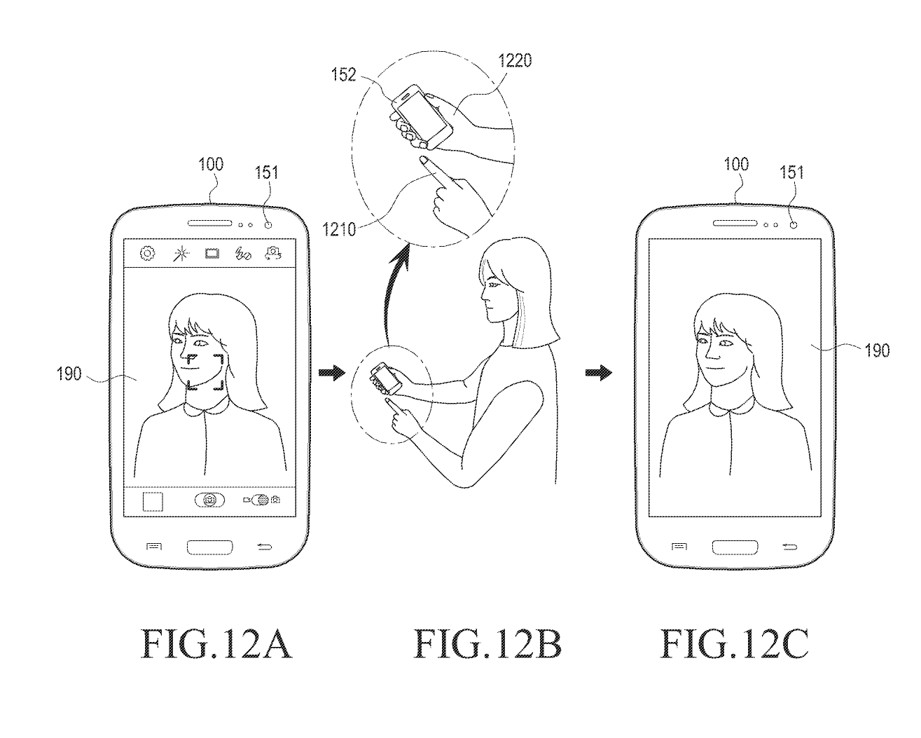

FIGS. 12A, 12B, and 12C illustrate a screen for describing the photography method using the grip sensor device according to the second embodiment of the present disclosure.

Referring to FIGS. 11, 12A, 12B, and 12C, a mobile electronic device 100 may execute a camera application, in operation 1110. The mobile electronic device 100 may execute the camera application though an interface with a user, or may execute a camera application that is downloaded from an external device (not illustrated) and installed. The camera application may also correspond to a camera function defined in advance in the mobile electronic device 100. When the camera application is executed, a first camera 151 or a second camera 152 may be turned on, and a preview screen may be displayed, as illustrated in FIG. 12A.

The mobile electronic device 100 determines whether a grip is detected, in operation 1120. For example, while the preview screen is displayed as illustrated in FIG. 12A, the mobile electronic device 100 may determine whether the grip is detected, according to a contact or proximity detection signal from the grip sensor device 700. For example, when a user performs a grip motion on a mounting location of an NFC antenna 730 disposed at a rear cover 31 side of the mobile electronic device 100 with his/her hand as illustrated in FIG. 12B, a contact or proximity detection signal may be generated. When the contact or proximity is made by the user, a grip sensor 710 may perform a grip sensing operation by detecting a change in a current of several mA generated from the NFC antenna 730 by the contact or proximity, for example, a change in permittivity, and may output a detection signal as a result of the grip sensing operation.

When the grip is detected, the mobile electronic device 100 determines whether a body part not used for the grip motion is approaching or moves away from the mobile electronic device 100, in operation 1130. For example, the mobile electronic device 100 may detect, through a touch screen 190, at least one approach or separation by various objects, for example, the user's body (e.g., fingers including a thumb) or a touchable input device, for example, the input unit 168 such as an electronic pen (a stylus pen). In another example, the mobile electronic device 100 may detect, through a proximity sensor 174, at least one approach to or separation from the mobile electronic device 100 by the user's body (e.g., fingers including a thumb) or a touchable input device, for example, the input unit 168 such as an electronic pen (a stylus pen).

When the approaching or separation of the body part not used for the grip motion is detected, the mobile electronic device 100 may perform a photography function of the camera application, in operation 1140. For example, as illustrated in FIG. 12C, the mobile electronic device 100 may perform the photography function, and may display a photo taken.

According to the above-described second embodiment of the present disclosure, the user may take a photo by approaching his/her left hand 1210 to the mobile electronic device 100 while gripping the mobile electronic device 100 with his/her right hand 1220.

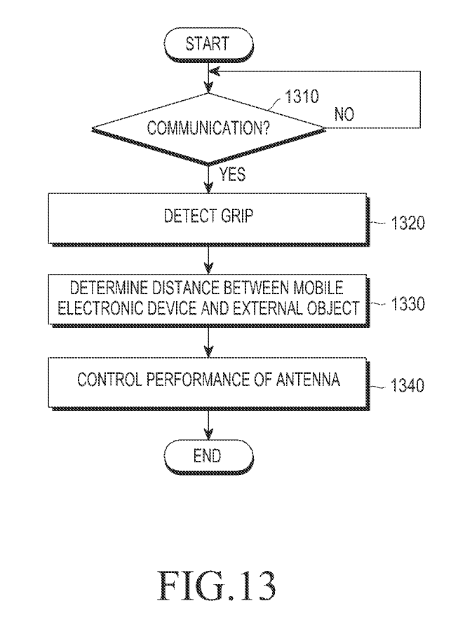

FIG. 13 is a flowchart illustrating a method of controlling a performance of an antenna by using a grip sensor device 700 according to an embodiment of the present disclosure.

Referring to FIG. 13, a mobile electronic device 100 may perform communication, in operation 1310. The mobile electronic device 100 may perform communication for a telephone call, communication for internet access, and the like through an interface with a user.

The mobile electronic device 100 detects a grip, in operation 1320. For example, when a user contacts or approaches a mounting location of an NFC antenna 730, the mobile electronic device 100 may detect the user's grip for the mobile electronic device 100 by detecting a change in a current generated from the NFC antenna 730 by the contact, for example, a change in permittivity through a grip sensor 71.

When the grip is detected, the mobile electronic device 100 determines a distance between the mobile electronic device 100 and an external object such as the user's finger, in operation 1330. The mobile electronic device 100 may determine the distance between the mobile electronic device 100 and the external object such as the user's finger according to an increase or decrease in the permittivity change. When the permittivity is increased, the distance between the mobile electronic device 100 and the external object such as the user's finger may be relatively short, and when the permittivity is decreased, the distance between the mobile electronic device 100 and the external object such as the user's finger may be relatively long.

The mobile electronic device 100 controls a performance of an antenna performing communication, in operation 1340. At this time, the antenna performing the communication may be a mobile communication antenna 145-1 in a case of telephone communication, or a sub-communication antenna 145-2 in a case of sub-communication. Furthermore, the antenna performing the communication may be an NFC antenna 145-3 in a case of NFC communication, a broadcast communication antenna 145-4 in a case of broadcast communication, or a GPS antenna 145-5 in a case of GPS communication. At this time, the mobile electronic device 100 may adjust characteristic impedance of the antenna performing the communication as a predetermined value in order to improve a transmission/reception performance of the antenna performing the communication.

According to the various embodiments of the present disclosure as described above, the user performs the photography operation by using the grip motion of holding or grasping the mobile electronic device 100. Thus, the user can more easily perform a self-photography operation by taking a grip motion such as contact with his/her hand holding the mobile electronic device 100. Furthermore, according to the various embodiments of the present disclosure, when the user performs communication by using the mobile electronic device 100, the mobile electronic device 100 detects the grip motion of holding or grasping itself and makes a control such that the performance of the antenna is not degraded by the grip motion, thereby preventing degradation of the communication performance due to the user's grip motion.

The methods according to the various embodiments of the present disclosure may be implemented in the form of a program command executed through various computer processes to be recorded in a computer readable medium. The computer readable medium may include a program command, a data file, a data structure, and the like independently or in combination. The program command recorded in the computer-readable medium may be one which is specifically designed and configured for the present disclosure, or may be well-known to and used by a person ordinarily skilled in the art of computer software.

It can be seen that the method of performing the function by using the grip sensing operation according to the various embodiments of the present disclosure can be implemented in a form of hardware, software, or a combination of hardware and software. Any such software may be stored, for example, in a volatile or nonvolatile storage device such as a ROM, a memory such as a RAM, a memory chip, a memory device, or a memory IC, or a recordable optical or magnetic medium such as a CD, a DVD, a magnetic disk, or a magnetic tape, regardless of its ability to be erased or its ability to be re-recorded. It can be also appreciated that the memory included in the mobile terminal is one example of machine-readable devices suitable for storing a program including instructions that are executed by a processor device to thereby implement various embodiments of the present disclosure. Accordingly, the present disclosure includes a program for a code implementing the apparatus and method described in the appended claims of the specification and a machine (a computer or the like)-readable storage medium for storing the program. Further, the program may be electronically transferred by any communication signal through a wired or wireless connection, and the present disclosure appropriately includes equivalents of the program.

Furthermore, the mobile electronic device according to the various embodiments of the present disclosure may receive and store the program from a program providing device connected thereto in a wired or wireless manner. The program providing device may include a memory for storing programs including instructions allowing the user interface methods according to the various embodiments of the present disclosure to be performed, a communication unit for performing wired or wireless communication with the mobile electronic device, and a controller for controlling the corresponding program to be transmitted through the communication unit according to a request of the mobile electronic device or automatically.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A grip sensor device comprising:
an antenna that is formed of metal within a mobile electronic device and communicates a signal of a first frequency; and
a grip sensor module that is formed within the mobile electronic device, is electrically connected to the antenna, and outputs a proximity detection signal according to proximity of an external object to the antenna.

2. The grip sensor device of claim 1, wherein the grip sensor module detects a change in permittivity of the antenna as a user grasps the mobile electronic device to approach the antenna.

3. The grip sensor device of claim 1, wherein the grip sensor module provides a signal of a second frequency less than the first frequency to the antenna, and detects a change in the signal of the second frequency when the external object approaches the antenna.

4. The grip sensor device of claim 1, further comprising:
a communication module that is electrically connected to the antenna, and controls the signal of the first frequency to be transmitted/received through the antenna.

5. The grip sensor device of claim 1, further comprising:
a low pass filter that is electrically connected between the antenna and the grip sensor module, prevents the signal of the first frequency from being provided to the grip sensor module, and allows a signal of a second frequency less than the first frequency to pass to the grip sensor module.

6. The grip sensor device of claim 1, further comprising:
a coil that is connected at one end thereof to the antenna and at an opposite end thereof to the grip sensor module,
wherein the coil prevents the signal of the first frequency from being provided to the grip sensor module.

7. The grip sensor device of claim 5, further comprising:
a noise attenuating device that is electrically connected between the antenna and the grip sensor module, and removes noise introduced from the antenna to the grip sensor module.

8. The grip sensor device of claim 5, further comprising:
a resistor that is connected at one end thereof to the coil and at an opposite end thereof to the grip sensor module,
wherein the resistor removes noise introduced from the antenna to the grip sensor module.

9. The grip sensor device of claim 1, wherein the antenna comprises a Near Field Communication (NFC) antenna.

10. The grip sensor device of claim 9, wherein the NFC antenna is disposed in a rear cover of the mobile electronic device.

11. The grip sensor device of claim 9, wherein the NFC antenna is disposed at a battery mounted to the mobile electronic device.

12. The grip sensor device of claim 1, further comprising:
a communication module that controls the signal of the first frequency to be wirelessly communicated through the antenna;
an antenna matching unit that is located between the communication module and the antenna to match the antenna; and
a noise attenuating circuit that is located between the antenna matching unit and the communication module, and reduces noise introduced from the antenna to the communication module.

13. The grip sensor device of claim 1, wherein the antenna comprises one of a Near Field Communication (NFC) antenna, a Bluetooth antenna, a Zigbee antenna, a mobile communication antenna, a Wi-Fi antenna, a Global Positioning System (GPS) antenna, a broadcast communication antenna, and an antenna for wireless charging.

14. A method of sensing a grip, the method comprising:
providing a predetermined electrical signal to an antenna in a mobile electronic device;
detecting a change in the electrical signal when an external object approaches the antenna; and
outputting a proximity detection signal according to the detecting of the change in the electrical signal.

15. The method of claim 14, wherein the predetermined electrical signal is a signal of a second frequency less than a first frequency of a signal that the antenna communicates.

16. The method of claim 14, wherein the detecting of the change in the electrical signal comprises:
detecting a change in permittivity of the antenna as a user grasps the mobile electronic device to approach the antenna.

17. The method of claim 15, wherein the detecting of the change in the electrical signal comprises:
detecting a change in the signal of the second frequency when the external object approaches the antenna.

18. The method of claim 14, wherein the antenna comprises one of a Near Field Communication (NFC) antenna, a Bluetooth antenna, a Zigbee antenna, a mobile communication antenna, a Wi-Fi antenna, a Global Positioning System (GPS) antenna, a broadcast communication antenna, and an antenna for wireless charging.

19. A mobile electronic device comprising:
an antenna that is formed within the mobile electronic device and communicates a signal of a first frequency;
a sensor module that is formed within the mobile electronic device, is electrically connected to the antenna, and outputs a detection signal when an external object approaches the antenna; and
a controller that determines whether the mobile electronic device is gripped by a user, by using the detection signal output from the sensor module when the external object approaches the antenna, and controls a predetermined function of an application being executed within the mobile electronic device to be performed.

20. The mobile electronic device of claim 19, further comprising:
a display unit that displays an execution screen of the application.

21. The mobile electronic device of claim 19, further comprising:
a camera that is exposed to an outside through a rear cover of the mobile electronic device,
wherein the controller controls the camera to perform a photography function when the external object approaches the rear cover of the mobile electronic device.

22. The mobile electronic device of claim 21, wherein the controller controls the camera to perform the photography function when a body part of the user not used for gripping the mobile electronic device is approaching or moves away from the mobile electronic device while the mobile electronic device is gripped.

23. The mobile electronic device of claim 19, wherein the sensor module detects a change in a signal of a second frequency when the signal of the second frequency lower than the first frequency is provided to the antenna, and the controller controls characteristic impedance of a main antenna communicating a signal of a third frequency different from the first and second frequencies to be changed to prevent a wireless communication performance of the main antenna from being degraded by the external object, when the external object contacts the mobile electronic device.

24. The mobile electronic device of claim 23, wherein the main antenna comprises a mobile communication antenna.

25. A method of performing a function by using grip sensing in a mobile electronic device, the method comprising:
detecting whether the mobile electronic device is gripped by a user, by using a detection signal output from a sensor module when an external object approaches an antenna; and
performing a predetermined function of an application being executed in the mobile electronic device when the mobile electronic device is gripped by the user.

26. The method of claim 25, further comprising:
displaying an execution screen of the application.

27. The method of claim 25, wherein the performing of the predetermined function of the application being executed comprises:
performing a photography function by using a camera while a camera application is being executed.

28. The method of claim 27, wherein the performing of the predetermined function of the application being executed comprises:
controlling the camera to perform the photography function when a body part of the user not used for gripping the mobile electronic device is approaching or moves away from the mobile electronic device while the mobile electronic device is gripped.

29. A method of performing a function by using grip sensing in a mobile electronic device, the method comprising:
detecting whether the mobile electronic device is gripped by a user, by using a detection signal output from a sensor module when an external object approaches an antenna; and
changing characteristic impedance of a main antenna to prevent a wireless communication performance of the main antenna from being degraded when the mobile electronic device is gripped by the user.

30. The method of claim 29, wherein the main antenna comprises a mobile communication antenna.
